(19) United States
(12) Patent Application Publication
(10) Pub. No.: US 2026/0231104 A1
(43) Pub. Date: Aug. 6, 2026

(54) SYSTEMS AND METHODS FOR SIDELINK POSITIONING ENHANCEMENT

(71) Applicant: ZTE CORPORATION, Shenzhen (CN)

(72) Inventors: Mengzhen LI, Shenzhen (CN); Chuangxin JIANG, Shenzhen (CN); Yu PAN, Shenzhen (CN); Qi YANG, Shenzhen (CN); Cong WANG, Shenzhen (CN); Junpeng LOU, Shenzhen (CN)

(73) Assignee: ZTE CORPORATION, Shenzhen (CN)

(21) Appl. No.: 19/577,899

(22) Filed: Mar. 25, 2026

Related U.S. Application Data
(63) Continuation of application No. PCT/CN2023/122958, filed on Sep. 28, 2023.

(51) Int. Cl. H04W 64/00; H04W 72/25

(52) U.S. Cl. CPC H04W 64/00; H04W 72/25

(57) ABSTRACT

Presented are systems and methods for sidelink positioning enhancement. A first wireless communication device (e.g., UE) can determine information regarding a Sidelink Positioning Reference Signal (SL PRS) transmission, in response to the first wireless communication device receiving a positioning request. The first wireless communication device can transmit an SL PRS and a Sidelink Control information (SCI) corresponding to the SL PRS based on the information regarding the SL PRS transmission.

### CROSS-REFERENCE TO RELATED APPLICATION

This application claims the benefit of priority under 35 U.S.C. § 120 as a continuation of International Patent Application No. PCT/CN2023/122958, filed on Sep. 28, 2023, the disclosure of which is incorporated herein by reference in its entirety.

### TECHNICAL FIELD

The disclosure relates generally to wireless communications, including but not limited to systems and methods for sidelink positioning enhancement.

### BACKGROUND

Sidelink (SL) communication refers to wireless radio communication between two or more User Equipments (UEs). In this type of communications, two or more UEs that are geographically proximate to each other can communicate without being routed to a Base Station (BS) or a core network. Data transmissions in SL communications are thus different from typical cellular network communications, which include transmitting data to a BS (e.g., uplink transmissions) and receiving data from a BS (e.g., downlink transmissions). In SL communications, data is transmitted directly from a source UE to a target UE through, for example the Unified Air Interface (e.g., PC5 interface) without passing through a BS.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A first wireless communication device (e.g., UE) can determine information regarding a Sidelink Positioning Reference Signal (SL PRS) transmission, in response to the first wireless communication device receiving a positioning request. The first wireless communication device can transmit/send/provide/communicate/forward an SL PRS and a Sidelink Control information (SCI) corresponding to the SL PRS based on the information regarding the SL PRS transmission.

In some implementations, the first wireless communication device can receive the positioning request from at least one of: a higher layer of the first wireless communication device; or a second wireless communication device. In some implementations, one or more wireless communication devices may receive/obtain/acquire the SCI and associated SL PRS resources from a second wireless communication device. The first wireless communication device may be one of the one or more wireless communication devices. The SCI transmitted by the second wireless communication device can include at least one of: a cast type, a source ID, a destination ID, and/or an SL PRS request field.

In some implementations, the positioning request in SCI, which is transmitted by the second wireless communication device, and the SL PRS resources, transmitted by the second wireless communication device, may share at least one of: a same cast type, a same source ID, and/or a same destination ID. In some implementations, a positioning request field in the SCI may be disabled, in response to at least one of following conditions being satisfied: the SL PRS request field is not preconfigured, configured, or enabled in a resource pool; the cast type is indicated as broadcast; and/or the cast type is indicated as groupcast.

In some implementations, the SCI further can include/comprise a requested ID. The requested ID can be configured for indicating which of the one or more wireless communication devices is requested to transmit an SL PRS in response to the positioning request. In some implementations, the requested ID can include at least one of: a UE ID indicated by a first higher layer, a source ID indicated by a second higher layer, and/or a member ID for groupcast case which is indicated by a third higher layer and represents a member in a group.

In some implementations, the first to third higher layers may each be a Sidelink Positioning Protocol (SLPP) signaling and/or a signaling sent from an application layer. In some implementations, the first to third higher layers may each be configured to inform which of the one or more wireless communication devices is requested to transmit an SL PRS in response to the positioning request and include SL PRS transmission characteristics.

In some implementations, the SL PRS transmission characteristics can comprise at least one of: positioning condition; Quality of Service (QoS) condition; SL PRS transmission priority of a target wireless communication device; SL PRS configurations; latency condition; and/or a UE ID. In some implementations, if the first wireless communication device and the second wireless communication device are in a same positioning session and the first wireless communication device receives the positioning request from the second wireless communication device, the first wireless communication device can be configured to transmit the SL PRS.

In some implementations, a resource selection or allocation for the SL PRS transmission of the first wireless communication device from a list of wireless communication devices receiving the positioning request can account for UE information or group member information. In some implementations, if the first wireless communication device is in SL PRS resource allocation scheme 2, the first wireless communication device can determine one or more SL PRS resource IDs for transmitting the SL PRS considering a maximum number of SL PRS resources configured or pre-configured in a resource pool and the UE information or the group member information, in response to the positioning request.

In some implementations, if the first wireless communication device is in SL PRS resource allocation scheme 2, the first wireless communication device can determine one or more SL PRS resource pool IDs for transmitting the SL PRS, in response to the positioning request. In some implementations, the second wireless communication device can use a Sidelink Positioning Protocol (SLPP) to recommend or configure different SL PRS characteristics for the first wireless communication device or one or more other wireless communication devices.

In some implementations, the first wireless communication device can transmit/send in response to receiving the positioning request sent from the second wireless communication device, the SL PRS in either unicast, groupcast, and/or broadcast. A destination of the SL PRS transmission can be configured or pre-configured to include the second wireless communication device. In some implementations, the first wireless communication device can determine to transmit the SL PRS on a shared resource pool. The information regarding the SL PRS transmission can include at least one of: a time resource, a frequency resource, an SL grant, a priority, a source ID, a destination ID, a resource pool ID, a bandwidth, a sidelink channel occupancy ratio (SL CR) limit, a maximum transmission power, an SL PRS resource ID, and/or a resource reservation interval.

In some implementations, the first wireless communication device can determine one or more SL PRS transmission parameters based on one or more delay budgets. In some implementations, the one or more delay budgets may each include a remaining delay budget of the SL PRS and a remaining packet delay budget (PDB) of SL data available in a logic channel or a unified delay budget. The unified delay budget may be a minimum value between the remaining delay budget of the SL PRS and the remaining PDB of the SL data available in the logic channel.

In some implementations, the information regarding the SL PRS transmission may be related to both of a list of PSSCH transmission parameters and a list of SL PRS transmission parameters. In some implementations, the list of SL PRS transmission parameters may be associated with a priority of the SL PRS transmission and a Channel Busy Ratio (CBR) measurement.

In some implementations, the list of PSSCH transmission parameters may be associated with a priority of PSSCH transmission and a CBR measurement. In some implementations, the information regarding the SL PRS transmission may be related to at least one of: a priority of the SL PRS, a priority of logical channels for SL data, a remaining delay budget of SL data available in a logical channel, and/or a delay budget of the SL PRS.

In some implementations, the first wireless communication device can select a destination associated with one of unicast, groupcast, and/or broadcast, having a highest priority among a priority of logical channels for SL data and a priority of the SL PRS for the SCI corresponding to the SL PRS transmission. In some implementations, the SL PRS may be transmitted by the first wireless communication device when there is a pending SL PRS under the selected destination and the pending SL PRS meets at least one restriction. The at least one restriction can comprise at least one of: the pending SL PRS having the highest priority; the pending SL PRS having a lowest delay budget; and/or the pending SL PRS transmitted in response to a single positioning request is not transmitted for more than N times or more than a time duration.

In some implementations, a third wireless communication device can receive the SL PRS transmitted by the first wireless communication device. The third wireless communication device can send an indication of at least one of a relative distance, an angle, or a resource pool ID in a location information report. In some implementations, the first wireless communication device can perform partial sensing to select available resources for the SL PRS transmission. At least one of: the partial sensing can be performed in SL Discontinuous Reception (DRX) inactive time based on resource pool configuration; SL PRS Received Signal Strength Indicator (RSSI) of a Channel Busy Ratio (CBR) may be measured in SL PRS resources where the first wireless communication device performs the partial sensing; and/or a CBR may be used if a threshold is not met where the threshold is calculated by a number of SL PRS resources in a CBR window.

In some implementations, the first wireless communication device can transmit the SL PRS in an unlicensed band. The selection of cyclic prefix extension (CPE) starting position or CPE length may be associated with a priority value of the SL PRS transmission.

In some implementations, a third wireless communication device can receive and measure SL PRS from one or more other wireless communication devices. The third wireless communication device can perform (or finish) one or more SL PRS measurements within a measurement period, where at least one of: the first wireless communication device can be one of the one or more other wireless communication devices; the third wireless communication device can receive a location information request from another wireless communication device or a network function via a Sidelink Positioning Protocol (SLPP) signaling; and/or the third wireless communication device can receive an assistance data from another wireless communication device or a network function via an SLPP signaling for measuring the SL PRS.

In some implementations, the measurement period can be associated with at least one of: quality of service (QoS) condition (or requirement), one or more delay budgets of the SL PRS transmission; one or more selection window sizes; one or more periodicities of (configured grant (CG) for SL positioning; one or more resource reservation period of SL PRS; a maximum number of active SL PRS resources across configured resource pools that one or more wireless communication devices are processing in a time duration; and/or maximum number of SL PRS resources (pre-)configured across configured resource pools in a time duration.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example depiction of transmissions of sidelink control information (SCI) 1 and SCI 2, in accordance with some embodiments of the present disclosure; and

FIG. 4 illustrates a flow diagram of an example method for sidelink positioning enhancement, in accordance with some embodiments of the present disclosure.

### DETAILED DESCRIPTION

### 1. Mobile Communication Technology and Environment

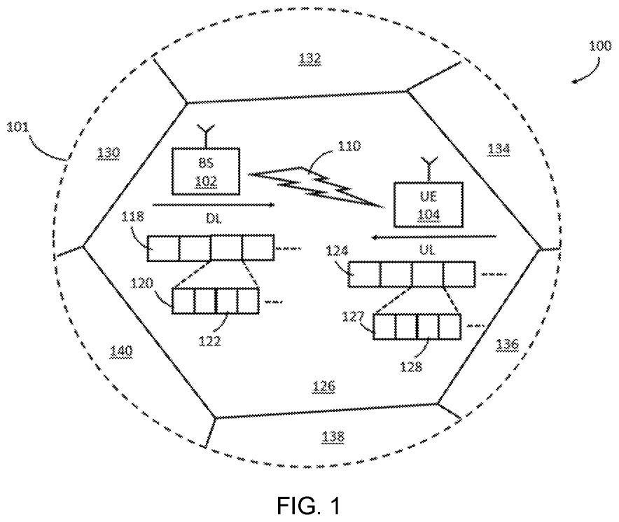

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

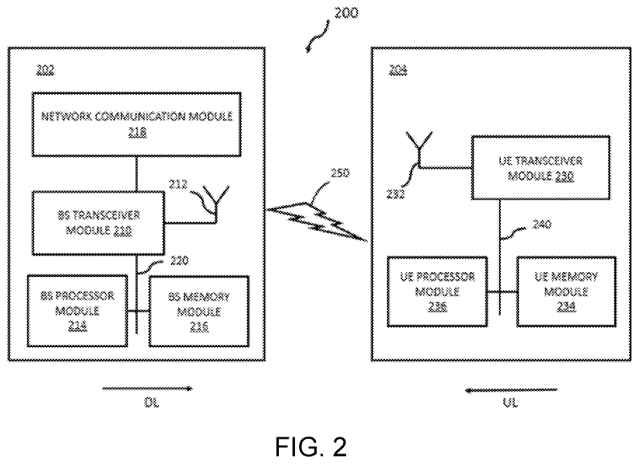

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Accuracy Improvement for Sidelink Positioning Enhancement

In certain systems, for physical sidelink control channel (PSCCH) and/or physical sidelink shared channel (PSSCH) resource allocation in SL communication, the time granularity can be slot and the sub-channel may be defined as PSSCH frequency resource unit, where the size of the sub-channel may be configured per resource pool. In some cases, both SL channel busy ratio (CBR) and SL channel occupancy ratio (SL CR) used for SL congestion control may be defined based on the sub-channel busy or sub-channel occupancy ratio. However, for SL positioning, SL PRS allocation granularity may apply slot-based and/or sub-channel-based SL PRS resource allocation, sub-slot-based SL PRS resource allocation, and/or SL PRS-resource-based allocation. For example, different from the PSCCH and/or PSSCH resource allocation in SL communication, where the time granularity is slot-based and the frequency granularity is sub-channel-based, SL PRS resource and/or SL PRS resource set can be defined and used as resource allocation granularity.

In certain configurations, aspects for supporting the sidelink positioning may include/involve, for instance, the design of sidelink positioning reference signal (SL PRS), measurements and reporting for SL positioning according to various positioning techniques or methods (e.g. round trip time (RTT), time difference of arrival (TDOA), angle-based positioning methods, etc.), and/or resource allocation for SL PRS (e.g., according to at least one or both of dedicated resource pool for SL PRS and/or shared resource pool, and/or at least one or both of resource allocation scheme 1 and scheme 2, etc.). With regards to the SL PRS resource allocation, at least one or both of the scheme 1 (e.g., network-centric operation SL PRS resource allocation) and/or scheme 2 (e.g., UE autonomous SL PRS resource allocation) may be introduced or implemented for supporting SL positioning and/or ranging.

In some other aspects, according to the mechanism of SL PRS sequence configuration, congestion control for SL positioning and inter-UE coordination (IUC) may be configured or designed. In various implementations, the systems and methods of the technical solution discussed herein can provide features or operations of signaling for sidelink positioning enhancement. In some configurations, the UE 104 may be a device of the user, a vehicle, a road-side unit (RSU), a positioning reference unit (PRU), or other devices, which may be capable of supporting vehicle-to-everything (V2X) services and/or SL communication. The UE 104 can be with or without a known position.

### Example Implementation 1: Triggering SL PRS

In various configurations, to trigger the SL PRS transmission of the UE 104 (e.g., UE-B), at least the following example operations can be considered. For example, the higher layer of the UE 104 (e.g., UE-B) may trigger the SL PRS transmission at the physical layer. In another example, another UE (e.g., UE-A) can trigger the SL PRS transmission of the UE 104 (e.g., UE-B). In various cases, the signaling may be lower layer signaling (e.g., SL PRS signaling, sidelink control information (SCI) signaling, medium access control control element (MAC CE) signaling, etc.), higher layer signaling (e.g., sidelink positioning protocol (SLPP) signaling, etc.), or both higher layer and lower layer signalings. In some cases, for both examples for triggering the SL PRS transmissions, the UE-B higher layer may determine/decide whether to trigger SL PRS transmission or not. As discussed herein, the UE 104 may refer to the UE-A or UE-B, among other UEs discussed herein, depending on the configuration. In some implementations, the UE-B may correspond to a first UE (e.g., first wireless communication device) and the UE-A may correspond to a second UE (e.g., second wireless communication device), or vice versa.

### Example Configuration 1.1: Destination of SCI Triggering

In various implementations, when UE-B SL PRS transmission is triggered by UE-A, at least one of the following example operations/methods should be supported:
1. The UE-A can transmit/send/provide SCI and an associated SL PRS. The SCI can be at least one of SCI 1-B used in a dedicated resource pool, and/or SCI 1-A and/or SCI2-D used in a shared resource pool. The SCI may include an “SL PRS request” field to trigger one or more other UEs 104 SL PRS transmission. The SCI may include at least one of a cast type indicator (e.g., indicating whether the transmission of the UE-A is broadcast, groupcast, or unicast), source ID, destination ID, etc.
2. The UE-B can be the transmission destination of the UE-A. The UE-B can receive the “SL PRS request” from the UE-A. Subsequently, the higher layer of the UE-B can transmit SL PRS in response to the request of the UE-A.

During the example operations/procedures hereinabove, the SL PRS request transmitted by the UE-A and the SL PRS transmission of the UE-A may share the cast type, source ID, and/or the destination ID, among others. For example, if the cast type of the SL PRS transmission of the UE-A is unicast, one UE-B can receive the “SL PRS request” from the UE-A. In another example, if the cast type of SL PRS transmission of the UE-A is groupcast, then a group of one or more UE-Bs may transmit the SL PRS in response to the respective UE-B receiving the SL PRS request from the UE-A. In yet another example, if the cast type of the SL PRS transmission of the UE-A is broadcast, any of the one or more UE-Bs can receive the SL PRS request. In this case, in response to the UE-B successfully decoding the SCI and SL PRS of the UE-A, the UE-B can transmit SL PRS in response to UE-A SL PRS request, for example.

In some implementations, in regards to the use case of SL PRS transmission triggered by another UE 104, unicast SL PRS request can be used in SL RTT method or configuration, which may involve SL PRS transmission round-trip between two UEs 104. One or more of the following example conditions/criteria may be satisfied/met to disable “SL PRS request” field in SCI:
The “SL PRS request” field in SCI may not be (pre-)configured or activated/enabled in a resource pool;
The cast type indicator in SCI can indicate broadcast; and/or
The cast type indicator in SCI can indicate groupcast.

For example, when the cast type is not broadcast and “SL PRS request” field in SCI is configured or activated/enabled in the resource pool, the “SL PRS request” field may be (or remain) enabled. Otherwise, UE-B can ignore or disregard the “SL PRS request” field. If “SL PRS request” field in SCI is configured in the resource pool but the cast type is broadcast, the field (e.g., the “SL PRS request” field) can be reserved.

In another example, when the cast type is unicast and “SL PRS request” field in SCI is configured in the resource pool, the “SL PRS request” field can be enabled. Otherwise, UE-B can ignore or skip the “SL PRS request” field. If “SL PRS request” field in SCI is configured in the resource pool but the cast type is not unicast, the field can be reserved.

### Example Configuration 1.2: Destination of SCI Triggering

In some implementations, the SL PRS request transmitted by UE-A and SL PRS transmission of the UE-A may not share the same cast type, source ID, and/or destination ID, among other information. For instance, not all UE-B(s) which is/are matched receivers of the SL PRS transmission from the UE-A (e.g., not all UE-Bs that received the SL PRS transmission) may be configured to respond to the “SL PRS request”. In such cases, one or more of the following example features can be supported:
A “requested ID” field can be included in SCI. In this case, the requested ID can be used for indicating the certain UE-B or member UE-B which may transmit SL PRS in response to the request in groupcast or broadcast SL PRS transmission of the UE-A. Other UEs 104 receiving SL PRS request of the UE-A may not be required to trigger their SL PRS transmission, for example.
   The requested ID can include or correspond to a member ID in groupcast. The member ID can be indicated by at least one higher layer signaling. For example, the member ID can be configured for each SLPP session. For instance, for one SLPP session, different UEs 104 may have the same destination ID (e.g., groupcast and/or broadcast) indicated with different member IDs.
   The requested ID can be a UE ID, where the UE ID may be indicated by at least one higher layer signaling. For example, the UE ID can be configured for each SLPP session. In this case, for one SLPP session, different UEs 104 may have the same destination ID (e.g., groupcast or broadcast) indicated with different UE IDs. For groupcast or broadcast, the UE ID can be a source ID indicated by higher layer signaling. A server UE (e.g., a UE supporting at least one of but not limited to the following example functionalities: positioning method determination, anchor UE selection, assistant data distribution, and/or location calculation), a location management function (LMF) (e.g., network function), and/or a higher layer (e.g., application layer), among other devices, may assign a source ID to the UE 104. In some cases, an anchor UE and/or a target UE may be a server UE. In such case, the source ID of the UE 104 may not be selected by the UE 104 itself because other UEs 104 may self-select the same source ID, for example.
In some cases, additional “cast type indicator”, “source ID”, and/or “destination ID” can be dedicated for SL PRS requests in SCI.
Higher layer involvement can be supported, instead of using SCI. For example, higher layer interactions between the UEs 104 can be supported to inform the UEs 104 of which of the UEs 104 to respond to the request and may provide SL PRS transmission characteristics for UE-B. The higher layer signaling can include but is not limited to SLPP signaling.
   Via/through SLPP, the UE-A may provide at least one of the following example information or condition to the UE-B: positioning condition, quality of service (QoS) (e.g., horizontal accuracy, vertical accuracy, response time, velocity request, SL PRS delay budget, priority, etc.), priority, target UE's SL PRS transmission priority, other SL PRS configurations (e.g., number of symbols, comb size, comb offset, bandwidth, sequence ID, SL PRS resource ID, resource pool ID, shared resource pool, and/or dedicated resource pool, to name a few), latency condition (e.g., UE-B can transmit SL PRS within a period of time after receiving SCI with SL PRS request), requested UE ID, etc.
      In some implementations, the one or more UEs 104 which received one of more of the above information and SCI triggering (e.g., SL PRS request in SCI) may be triggered to transmit SL PRS. For example, in the case of groupcast, the group members (e.g., the group of UE(s) 104) receiving/obtaining the higher layer information may be triggered.
   If one or more UE-Bs do not have a signaling unicast link (e.g., SLPP unicast link) with UE-A, but receive SCI triggering, the one or more UE-Bs may not be configured to transmit SL PRS, for example.
   In some cases, if the UE-A and UE-B (e.g., the first and second wireless communication devices) are in the same positioning session and UE-B receives SCI triggering from the UE-A, the UE-B may transmit SL PRS in response to the request from the UE-A. For example, UE-A and UE-B may share the same SLPP session ID, and/or UE-A and UE-B may involved or be associated with the same location services (LCS) request. The SL PRS transmission of UE-B may follow the SL PRS configuration (e.g., SL PRS assistance data) in the SLPP session.

### Example Configuration 1.3: Potential Management for a List of UE-B(s) Receiving SL PRS Request

If groupcast or broadcast SCI-based triggered SL PRS request is supported, in certain scenarios, a group of UE-B(s) can select/choose the same SL PRS resource at the same time-frequency resources. In such scenarios, potential conflicts may occur due to SCI-based triggered SL PRS request of the UE-A. To mitigate the potential conflict, one or more of the following example operations or features can be supported:
1. Certain rules can be configured/set to alleviate potential resource conflict.
   In some cases, a list of SL PRS transmissions from one or more UE-Bs in response to the same SL PRS request of the UE-As may at least share at least one of the following example conditions/criteria: SL PRS priority, bandwidth, SL PRS resource ID, number of symbols, and/or resource pool index, to name a few.
   The resource selection/allocation of the UE-B from the list of one or more UE-Bs receiving SL PRS requests can take UE information and/or group member information into account (e.g., account for the UE information and/or group member information).
      The UE-B from the list of one or more UE-Bs receiving SL PRS requests may select/choose different SL PRS resources in consideration of or according to the UE ID information, e.g., U_ID. The UE ID information can be a source ID and/or a UE ID from/via the higher layer signaling. The UE-B(s) may self-select a source ID, or in some cases, at least one of a server UE, the LMF, and/or a higher layer (e.g., application layer) may assign a source ID to the UE-B.
      A UE-B from the list of UE-B(s) receiving SL PRS requests may select different SL PRS resources considering the group member information M_ID, where the member ID may be indicated by higher layers. For example, the member ID can be configured for each SLPP session. For instance, for one SLPP session, different UEs 104 having the same destination ID (e.g., groupcast or broadcast) may be indicated with different member IDs.
      If the UE-B is in SL PRS resource allocation scheme 2, the UE-B can determine one or more SL PRS resource ID(s) for an SL PRS transmission in response to an SCI-based triggered SL PRS request as U_ID mod N_(SL PRS), M_ID mod N_(SL PRS), and/or (U_ID+M_ID) mod N_(SL PRS), the N_(SL PRS) can be the total number of configured/pre-configured SL PRS resources in a resource pool. In such cases, different UEs 104 can perform sensing for different SL PRS resources.
      In another example, if the UE-B is in SL PRS resource allocation scheme 2, different UE-B(s) can avoid resource collision via transmitting SL PRS in different resource pools. For instance, if the N_pool can be the total number of configured transmission resource pools (e.g., may be dedicated resource pools, shared resource pools, both dedicated resource pools and shared resource pool), the UE-B can determine one or more SL PRS resource ID for a SL PRS transmission in response to a SCI-based triggered SL PRS request as U_ID mod N_pool, M_ID mod N_pool, and/or (U_ID+M_ID) mod N_pool.
      If UE-B is in SL PRS resource allocation scheme 1, the UE-B can decide or determine to transmit SL PRS in response to SL PRS request. Since the UE 104 (e.g., UE-B) has SL PRS to transmit, the UE 104 can send/transmit/communicate UL RRC message to the BS 102 (e.g., gNB or TRP) to request a configured grant (CG) or send UL BSR MAC CE to request a dynamic grant (DG). The request signaling from the UE 104 to the BS 102 may include at least of: one or more of a selected resource pool index, one or more selected SL PRS resource ID, destination ID, SL PRS priority, and/or buffer size, among others. The selected resource pool index or SL PRS resource ID by the UE 104 may follow or be in line with the same rule as in resource allocation scheme 2, for example. For example, if the BS 102 receives multiple UL MAC CE requests from multiple UEs 104, where the requests share the same destination and priority, the BS 102 can assign different resources (e.g., SL PRS resource, SL PRS resource pool, time resource assignment, frequency resource assignment, and/or CG index, etc.) to different UEs 104.
      Additionally or alternatively, frequency domain, time domain, and/or slot offset. For instance, there may be timing offsets among different UE-Bs. The unit of timing offset can be at least one of slot, symbol, and/or ms, or other units.
2. In some cases, higher layer signaling can be used to alleviate potential resource conflict.
   For example, the UE-A can use SLPP to recommend or configure different SL PRS characteristics for one or more different UE-B(s). The SL PRS characteristics can include at least one of but not limited to SL PRS resource ID, resource pool index, comb size, comb offset, number of symbols in a slot, priority, an SL PRS transmission slot, a list of SL PRS transmission slot, a bitmap for SL PRS time-domain resource, and/or a window of SL PRS transmission.
   The use case of higher layer configuration or recommendation may be confined or restricted to groupcast, broadcast, or a combination of groupcast and broadcast.

### Example Configuration 1.4: SL PRS Transmission Target of the UE-B

In various implementations, UE-B may receive SCI-based SL PRS triggering from the UE-A. In some cases, the UE-B may determine to transmit SL PRS accordingly. In such cases, one or more of the following example scenarios or features can be considered or applied:
The UE-B can send/transmit SL PRS to UE-A in response to the request from the UE-A.
The transmission of UE-B may depend on UE-B by itself, in response to the request from the UE-A, including the source ID, destination ID, and/or cast type, for example. In this case, the UE-A may not be one of SL PRS transmission destinations of the UE-B.
The UE-B can transmit SL PRS in response to the request from the UE-A in either unicast, groupcast, or broadcast configuration. The destination of SL PRS transmission from the UE-B can include the UE-A. In this case, the UE-B may have flexibility with a relatively small restriction, in consideration of the transmission target of SL PRS.

### Example Implementation 2: Shared Resource Pool MAC Configuration or Design

In various configurations, for SL PRS transmission in the dedicated resource pool and/or shared resource pool, the at least one of the following example operations/methods or procedures involving the MAC layer of the UE 104 can be configured:
1. The UE 104 can receive/obtain the SL PRS transmission request. The UE 104 can receive the request from the LMF and/or server UE, among other network devices, via SLPP signaling (or other higher layer signalings), or the UE 104 can receive the request from its own higher layer (e.g., application layer).
2. The SL grant for the SL PRS transmission may be obtained. The following schemes can be considered:
   SL PRS resource allocation scheme 1: the UE 104 can request SL grant from the BS 102. For example, the UE 104 can send an UL RRC message to the BS 102 to request a configured grant (CG). The UE 104 can send UL MAC CE to the BS 102 to request a dynamic grant (DG).
   SL PRS resource allocation scheme 2: the UE 104 may autonomously (e.g., automatically) select the SL grant (or other types of grants).
3. The SL transmission information may be determined, and the SL transmission information can be associated with the selected (e.g., scheme 2) or the indicated grant (e.g., scheme 1). In such cases, the UE 104 can transmit SL PRS and the associated SCI on the SL grant.

### Example Configuration 2.1: Packet Delay Budget (PDB)

In various implementations, the delay budget of SL PRS or SL data can impact the MAC layer of the UE 104 for resource or grant selection. For example, the impact may include at least one of the following examples: the selection of resource reservation interval can be associated with the remaining delay budget; in the scenarios of sensing-based resource selection, random selection, HARQ re-transmission, pre-emption, and/or re-evaluation, the MAC layer of the UE 104 may randomly select the time and frequency resources according to the delay budget; and/or the delay budget can be one of the factors that can cause Tx resource re-selection check or confirmation.

In SL communication, each quality of service (QoS) can be associated with a packet delay budget (PDB). For resource allocation mode 2, the MAC layer may (e.g., randomly or selectively) select the time and frequency resources for one transmission opportunity from the resource pool according to the remaining PDB. For SL PRS resource selection or re-selection, a delay budget for SL PRS can be introduced where the delay budget may be associated with a certain positioning service condition. Subsequently, how to determine the delay budget in the shared resource pool can be considered in consideration that SL PRS and SL data can be transmitted in the pool. For instance, the SL PRS and SL data may potentially share the same SL grant. In such cases, one or more of the following example operations can be applied or implemented:
A unified delay budget can be defined considering the delay budget of SL PRS and the PDB of SL data available in the logic channel(s). In some cases, a remaining unified delay budget can be defined, considering both the remaining delay budget of SL PRS and the remaining PDB of SL data available in the logic channel(s).
   The remaining unified delay budget can be a minimum value between remaining PDB of SL data and the remaining SL PRS delay budget.
   The unified delay budget can be a minimum value between the PDB of SL data and the SL PRS delay budget.
   The MAC entity can select a value for the resource reservation interval that is relatively larger than the remaining unified delay budget.
   For random resource selection, the time and frequency resources may be (e.g., randomly) selected for one transmission opportunity from the resources pool, according to the remaining unified delay budget.
   For sensing-based resource selection, the time and frequency resources may be (e.g., randomly) selected for one transmission opportunity from the resources indicated by the physical layer according to the remaining unified delay budget.
   If one or more HARQ retransmissions are selected, the time and frequency resources may be (e.g., randomly) selected for one transmission opportunity from the resources pool, according to the remaining unified delay budget and the selected number of HARQ retransmissions.
   For pre-emption or re-evaluation, the time and frequency resource may be (e.g., randomly) selected from the resources indicated by the physical layer for either the removed resource or the dropped resource, according to the selected number of HARQ retransmissions and the remaining unified delay budget.
   If transmission(s) with the selected sidelink grant cannot fulfill/satisfy/meet the remaining unified delay budget, and the MAC entity selects or determines not to perform transmission(s) corresponding to a single MAC PDU, the selected sidelink grant associated to the sidelink process may be cleared/removed/discarded, if available or selected. In some cases, the TX resource (re-)selection can be triggered/initiated/activated/started.
      3. If the remaining unified delay budget is not met, the UE implementation can determine whether to perform transmission(s) corresponding to a single MAC PDU or sidelink resource reselection.
In some cases, instead of defining a unified delay budget or a unified remaining delay budget, the selection of SL grant and/or (re-)selection check can consider at least the remaining delay budget of SL PRS and the remaining PDB of SL data.
   If there is SL PRS pending for transmission, the selection of SL grant and (re-)selection check can consider the remaining delay budget of SL PRS.
   The MAC entity can select a value for the resource reservation interval which may be relatively larger than the remaining delay budget of SL PRS and the remaining PDB of SL data if SL data is transmitted/sent.
   For random resource selection, the time and frequency resources can be (e.g., randomly) selected for one transmission opportunity from the resources pool, according to the remaining delay budget of SL PRS and remaining PDB of SL data if SL data is transmitted.
   For sensing-based resource selection, the time and frequency resources can be (e.g., randomly) selected for one transmission opportunity from the resources indicated by the physical layer according to the remaining delay budget of SL PRS and remaining PDB of SL data if SL data is transmitted.
   If one or more HARQ retransmissions are selected, the time and frequency resources can be (e.g., randomly) selected for one transmission opportunity from the resources pool, such as according to the remaining delay budget of SL PRS and remaining PDB of SL data if SL data is transmitted and the selected number of HARQ retransmissions.
   For pre-emption or re-evaluation, the time and frequency resource can be (e.g., randomly) selected from the resources indicated by the physical layer for either the removed resource or the dropped resource, such as according to the selected number of HARQ retransmissions and the remaining delay budget of SL PRS and remaining PDB of SL data if SL data is transmitted.
   If transmission(s) with the selected sidelink grant do not satisfy the remaining delay budget of SL PRS and remaining PDB of SL data if SL data is transmitted, and the MAC entity selects not to perform transmission(s) corresponding to a single MAC PDU, the selected sidelink grant associated to the sidelink process may be cleared, if available. Accordingly, the TX resource (re-)selection can be triggered/initiated.
      In some cases, if the remaining delay budget of SL PRS and the remaining PDB of SL data, if SL data is transmitted, is not met, the UE 104 can determine whether to perform transmission(s) corresponding to single MAC PDU and/or sidelink resource reselection.

### Example Configuration 2.2: Frequency Domain Allocation

For shared resource pool in SL positioning, multiple scenarios can be considered, including but not limited to, for example: SL PRS transmitted on the shared resource pool; SL data transmitted on the shared resource pool; SL data and SL PRS transmitted on the shared resource pool. In some cases, for shared resource pool, a single priority value can be provided by the higher layer to the physical layer, such as including when SL PRS and PSSCH are multiplexed in the same slot of a shared resource pool.

According to the (pre-)configuration, for a transmission priority, based on the CBR measurement, a list of PSSCH transmission parameters and/or a list of SL PRS transmission parameters can be defined/configured/provided. An example configuration can be provided, but not limited to, as follows:

| | |
|---|---|
| SL-PSSCH-TxParameters-r16 ::= | SEQUENCE |
| sl-MinMCS-PSSCH-r16 | INTEGER (0 . . . 27), |
| sl-MaxMCS-PSSCH-r16 | INTEGER (0 . . . 31), |
| sl-MinSubChannelNumPSSCH-r16 | INTEGER (1 . . . 27), |
| sl-MaxSubchannelNumPSSCH-r16 | INTEGER (1 . . . 27), |
| sl-MaxTxTransNumPSSCH-r16 | INTEGER (1 . . . 32), |
| sl-MaxTxPower-r16 | SL-TxPower-r16 |
| OPTIONAL -- Cond CBR | |
| } | |
| SL PRS-TxParameters-r16 ::= | SEQUENCE { |
| sl-MinMCS-PSSCH-r16 | INTEGER (0 . . . 27), |
| sl-MaxMCS-PSSCH-r16 | INTEGER (0 . . . 31), |
| sl-MinSubChannelNumPSSCH-r16 | INTEGER (1 . . . 27), |
| sl-MaxSubchannelNumPSSCH-r16 | INTEGER (1 . . . 27), |
| sl-MaxTxTransNumPSSCH-r16 | INTEGER (1 . . . 32), |
| sl-MaxTxPower-r16 | SL-TxPower-r16 |
| OPTIONAL -- Cond CBR | |
| } | |

In various cases, if the SL PRS is transmitted on the shared resource pool, the frequency resources can be selected according to or based on the list of SL PRS transmission parameters (e.g., a minimum and/or maximum number of sub-channels may be used for SL PRS transmission) associated with the priority and CBR measure.

If the SL data is transmitted on the shared resource pool, the frequency resources can be selected according to the default SL data transmission configuration (e.g., minimum and/or maximum number of sub-channels may be used for PSSCH transmission) associated with the priority.

If the SL PRS and SL data are transmitted on the shared resource pool, the list of PSSCH transmission parameters and the list of SL PRS transmission parameters associated with the priority and CBR measure can be provided. The transmission parameters in the shared resource pool may include at least one of following: maximum transmission number for PSSCH or SL PRS, maximum transmission power, minimum and maximum modulation and coding scheme (MCS) values used for transmission, minimum and maximum number of sub-channels, and/or CR limit, among others.

In some implementations, at least one of the following features or operations can be implemented or applied:
The SL grant may be selected based on both the list of PSSCH transmission parameters and the list of SL PRS transmission parameters. In some cases, the bandwidth of SL PRS may be the same as the bandwidth of PSSCH. The transmission power of SL PRS may be the same as that of the PSSCH.
The intersection of the two frequency domain ranges (e.g., the minimum and maximum number of sub-channels) can be obtained from the list of PSSCH transmission parameters and/or the list of SL PRS transmission parameters.
The concatenation of the two frequency domain ranges (e.g., minimum and maximum number of sub-channels) can be obtained from the list of PSSCH transmission parameters and the list of SL PRS transmission parameters.
The maximum number between the maximum transmission power of SL PRS and the maximum transmission power of PSSCH can be obtained.
The minimum number between the maximum transmission power of SL PRS and the maximum transmission power of PSSCH can be obtained.
The maximum number between the CR limit of SL PRS and the CR limit of PSSCH can be obtained.
The minimum number between the CR limit of SL PRS and the CR limit of PSSCH can be obtained.
The intersection of the two MCS ranges (e.g., minimum and maximum number of MCS values) can be obtained from the list of PSSCH transmission parameters and the list of SL PRS transmission parameters.
The concatenation of the two MCS domain ranges (e.g., minimum and maximum number of MCS values) can be obtained from the list of PSSCH transmission parameters and the list of SL PRS transmission parameters.
In some cases, the UE 104 can consider the list of SL PRS transmission parameters or the list of PSSCH transmission parameters when selecting the SL grant.
In some cases, according to the list of PSSCH transmission parameters and the list of SL PRS transmission parameter, the UE 104 can determine how to select a suitable SL grant, for instance, the UE 104 may be configured with a suitable technique to determine how to select the suitable SL grant.

Via the configuration (e.g., pre-configuration), for a transmission priority, if CBR measurement is not available or invalid, a default PSSCH transmission configuration and a default SL PRS transmission configuration can be defined/configured/set.

Additionally or alternatively, for the shared resource pool, if there is no dedicated list of SL PRS parameters defined (e.g., default or impacted by CBR measurement and priority), one or more of but not limited to the example operations or features can be applied or considered:
If SL data is transmitted in the shared resource pool, the selection of SL grant can consider the list of PSSCH parameters (e.g., default or impacted by CBR measurement and priority).
If the SL PRS is transmitted in the shared resource pool and there is no SL data transmitted along in the same slot, one or more of the following examples can be applied:
   If there is no SL data pending for transmission, the UE 104 may perform multiplexing and assembly and generate a MAC PDU, where instead of actual data, the MAC PDU may include a SL-SCH sub-header and padding bits. The MAC layer of the UE 104 may assume the priority of “virtual” SL data (e.g., padding) is the same as the priority of SL PRS and determine a list of transmission parameters accordingly.
   Because the UE 104 can receive an SL PRS request which may include a positioning condition, the UE 104 can get the bandwidth (or number of sub-channels) according to the conditions/parameters (e.g., sometimes referred to as requirements).
   The selection of bandwidth (or number of sub-channels) for SL PRS transmission can consider the corresponding positioning requirement and the minimum and maximum restriction of sub-channel numbers for PSSCH (e.g., virtual SL data), for example.
If the SL PRS and SL data are transmitted in the shared resource pool, because in the shared resource pool, there may be one bandwidth, priority, and/or transmission power for the SL PRS and SL data, the selection of SL grant for SL PRS and SL data can consider the list of PSSCH parameters (e.g., default or impacted by CBR measurement and priority). The priority may be the highest priority value between the priority of SL PRS and SL data. Additionally or alternatively, the selection of bandwidth can consider the corresponding positioning requirement for SL PRS transmission and the minimum and maximum restriction of sub-channel numbers for PSSCH.
   Multiplexing and/or LCP Consideration

In some cases, methods for determining the selected destination can be considered. For example, several factors can be considered during the multiplexing procedure, including at least one of but not limited to: priority of SL PRS, priority of logical channels for SL data, remaining delay budget of SL data available in the logical channel(s), and/or delay budget of SL PRS.

One or more of the following non-limiting example features or operations can be applied:
Select a destination associated with one of unicast, groupcast, and/or broadcast, having the lowest delay budget among PDB of SL data available in logical channels and/or delay budget of SL PRS(s), and/or the highest priority among priority of logical channels for SL data and priority of SL PRS(s).
Select a destination associated with one of unicast, groupcast, and/or broadcast, satisfying the conditions of having the lowest delay budget among PDB of SL data available in logical channels and the highest priority among priority of logical channels for SL data.
The selected destination can prioritize SL data and consider SL data, such as at least selecting a destination associated with one of unicast, groupcast, or broadcast, having at least one of the MAC CE or the logical channel for SL data with the highest priority.
In scenarios where the SL PRS and SL data are transmitted in a shared resource pool or SL PRS is transmitted in a shared resource pool, the selected destination can consider at least one or both of the SL PRS and SL data. The destination associated with one of unicast, groupcast, or broadcast can be selected, having the highest priority among priority of logical channels for SL data and priority of SL PRS(s). There may be a list of SL PRS pending to transmit and different SL PRS may be transmitted in response to different positioning requests. In some cases, there may be a list of logical channels for SL data pending to transmit.
Select a destination associated with one of unicast, groupcast, or broadcast, having at least one of the MAC CE and the logical channel for SL data with the lowest delay budget.
The selected destination can consider at least one of both of SL PRS and/or SL data. In this case, the destination associated with one of unicast, groupcast, or broadcast can be selected, having the lowest delay budget among PDB of SL data available in logical channels and delay budget of SL PRS(s).

If the destination has the SL PRS pending, the multiplexing and assembly to construct MAC PDU associated with the SL grant between the SL PRS and the LCH data and/or MAC CE(s) can be considered or implemented. One or more of the following example implementations for multiplexing and assembly can be supported by the UE 104:
The SL PRS can be transmitted when there is a pending SL PRS under the selected destination.
SL PRS can be transmitted when SL PRS is both the highest priority and the lowest delay budget under the selected destination.
SL PRS can be transmitted when SL PRS is the highest priority under the selected destination.
SL PRS can be transmitted when SL PRS is the lowest delay budget under the selected destination.
SL PRS can be transmitted when the SL-SCH data with higher priority than the SL PRS is allocated in the MAC PDU.
SL PRS can be transmitted when there is a pending SL PRS under the selected destination and the pending SL PRS can satisfy/meet one or more predefined restrictions. The restriction can be for high priority SL PRS and/or low priority SL PRS, low delay budget SL PRS and/or high delay budget SL PRS. In some cases, the SL PRS transmission in response to a single positioning request may not be transmitted for more than N times or more than a time duration T. The number of N and T can be (pre-)configured. Additionally or alternatively, if SL PRS transmission in response to a single positioning request is transmitted for more than N times or more than a time duration T, the priority of this SL PRS transmission may be degraded in certain scenarios.

At least one of following non-limiting example procedures can be applied for resource selection:
Select resource(s) or destination satisfying high priority and lowest delay budget transmission. The transmission can be SL PRS transmission and/or SL data transmission.
If not, select resource(s) or destination satisfying the higher priority transmission. In this case, the transmission can be SL PRS transmission and/or SL data transmission.
In some cases, resource(s) or destination satisfying low delay budget can be selected.
If not, such as when there may not be a sufficient amount of resources to be selected/chosen, the UE 104 can be configured to select the resource(s) or destination.

When the MAC layer triggers the physical layer to perform sensing and report candidate resources, the MAC layer may provide resource pool, priority, delay budget, resource reservation period, list of resources for pre-emption, re-evaluation, and/or set of SL PRS resource ID(s) to the physical layer. In such cases, one or more of the following example configurations may be utilized:
The priority may consider at least one or both the priority of SL PRS pending to transmit and the priority of SL data pending to transmit.
The delay budget can consider at least one or both the PDB of SL data pending to transmit and/or the delay budget of SL PRS pending to transmit.

After selecting the SL grant and multiplexing and assembly, for each PSCCH duration on a shared resource pool, the MAC entity can perform at least one of the following example procedures:
Set the resource reservation period to the selected value, where the resource reservation period can be larger than the delay budget;
Set the source ID and destination ID corresponding to the SL PRS transmission, corresponding to the SL data transmission, and/or corresponding to SL PRS and SL data transmission; and/or
Set the priority as the highest value between priority as indicated by the higher layer (e.g., application layer or via the higher layer signaling) of selected SL PRS and/or the priority of selected logical channels.

### Example Implementation 3: Measurement Report for SL Positioning

In various configurations, for SL positioning, absolute positioning, relative positioning, and/or ranging may be supported. For relative positioning and/or ranging, after SL PRS transmission, the UE 104 or the LMF (e.g., network function) may expect to calculate/compute/determine the distance and/or angle of the target UE relative to another UE. In such cases, for UE-based positioning, the UE 104 can report the relative distance and angle to the LMF or another UE (e.g., server UE) via the SLPP signaling (or other types of signalings).

In some implementations, it may be considered whether to report the “resource pool ID” in the measurement report, when the SL PRS resource ID is reported or how the LMF/UE can use the reported resource ID. In such cases, the following non-limiting example operations or features can be applied or implemented:
For LMF-based SL positioning, for example:
   For the dedicated resource pool, the UE 104 can report the SL PRS resource ID and resource pool ID together in a measurement report.
   For the shared resource pool, the UE 104 can report SL PRS resource ID, resource pool ID, and SL PRS frequency domain allocation or bandwidth together in a measurement report. The SL PRS resource can be identified by the SL PRS resource ID and/or the SL PRS frequency domain allocation.
   For the LMF to determine how to use resource pool ID and the SL PRS resource ID, the LMF can obtain the per UE SL PRS resource pool configuration information. For example, one or more of the following example approaches can be used or implemented:
      4. The BS 102 can send the per UE SL PRS resource pool configuration information to the LMF via for instance NR positioning protocol A (NRPPa), which can include UE ID.
      5. The UE 104 (e.g., itself) can send per UE SL PRS resource pool configuration information to the LMF via SLPP signaling or other types of signalings.
      6. The server UE can send per UE SL PRS resource pool configuration information to the LMF via SLPP signaling or other types of signalings. The UE ID can be reported with the provided per UE SL PRS resource pool configuration information, for example.
For UE-based SL positioning:
   If the UE 104 that is performing the computation is a UE 104 involved in the SL PRS transmission, (e.g., anchor UE or target UE), the UE 104 may not report (or may be configured to skip reporting) the resource ID in the measurement report.
   If the UE 104 that performs the computation is neither the anchor UE or the target UE, the resource pool configuration of the anchor UE and the target UE can be reported to the serving UE 104 via assistance data, including the reporting of resource pool ID.

### Example Implementation 4: Power Saving

In various configurations, from the power-saving scenarios for the UE 104, partial sensing and/or SL DRX can be provided for SL positioning in the dedicated resource pool. In various cases, one or more of the following non-limiting example features or operations can be supported:
In some cases, the periodic-based partial sensing (PBPS) and/or contiguous partial sensing (CPS) can be allowed in a dedicated resource pool.
Whether the UE 104 performs SL PRS reception for partial sensing on slots in SL DRX inactive time can be activated/disabled by (pre-)configuration per dedicated resource pool. For instance, the configured per dedicated source pool can indicate whether the UE 104 can perform the SL PRS reception for partial sensing on slots in SL DRX inactive time.
CBR-related:
   SL PRS RSSI of CBR can be measured in the SL PRS resources, where the UE 104 can perform partial sensing if partial sensing can be performed based on (pre-)configuration.
   The (pre-)configured SL PRS threshold can be the number of SL PRS resources. If the number of SL PRS resources in the CBR window is larger than the threshold, the UE 104 can determine that the CBR measurement is valid.
   The (pre-)configured CBR, if the threshold cannot be satisfied/met for partial sensing in a dedicated resource pool.
   The (pre-)configured CBR for random resource selection in a dedicated resource pool.

### Example Implementation 5: CPE Configuration/Design for SL Positioning on Unlicensed Spectrum

In various configurations, the CP extension (CPE) can be supported for SL positioning in a shared channel (e.g., unlicensed band). For a dedicated resource pool, the CPE may be transmitted from a CPE starting position before PSCCH transmission and/or SL PRS transmission within a channel occupancy time (COT). The CPE can be transmitted within one or more symbols, for instance, relatively (e.g., immediately or just) before the next AGC symbol, the AGC symbol can either be the AGC symbol before PSCCH transmission or be the AGC symbol before each SL PRS resource. The one or more symbol(s) can be related to SCS, for example, based on (pre-) configuration, a CPE can be transmitted within one symbol just before the next AGC symbol for 15 kHz SCS and within 2 symbols just before the next AGC symbol for 30 kHz or 60 KHz SCS. With regards to the CPE for SL positioning including CPE starting position and/or other configurations, one or more of the following example features or operations can be applied or implemented:
A single CPE starting position or CPE length can be (pre-)configured for SL positioning. In this case, for either channel access type 1 or channel access type 2, the possibility of channel access success may be relatively more equal for the UEs 104. For example, if different UEs 104 share the same CPE starting positioning and/or CPE length, there may not be listen-before-talk (LBT) interference/block situation caused by different CPEs. The LBT block can refer to, for instance, once a UE 104 with a relatively longer CPE length occupy the channel, this UE 104 may make other UEs fail to access the channel because the channel is busy, in an example scenario.
Additionally or alternatively, at least one CPE starting position and/or CPE length for SL positioning can be (pre-)configured. The selection of CPE starting position and/or CPE length may be associated with priority value. The priority value can be the priority of SL PRS transmission and/or the channel access priority class (CAPC) value. In some implementations, one or multiple CPE starting position or CPE length can be (pre-) configured per priority value. In such cases, the UE 104 can (e.g., randomly) select at least one CPE config according to its SL PRS transmission priority and/or CAPC value. In some arrangements, the longer the CPE length, the greater the probability of successful channel access, for example.

For example, for SL PRS configuration in a shared channel, one or more starting symbol(s) can be (pre-)configured in a slot. In such cases, if in a slot a UE 104 fails to access a channel, there can be other chances or opportunities to assess the channel in a second (or third) starting symbol. The number and location of the starting symbol(s) in a slot can be (pre-) configured in each resource pool. The number and location of the starting symbol(s) in a slot from multiple resource pools can be aligned. The number and location of the starting symbol(s) in a slot can be (pre-)configured per BWP, per carrier, and/or per an unlicensed band. In each resource pool, one PSCCH configuration can be associated with one or more SL PRS resources. Different PSCCH configuration can be associated with the same one or more SL PRS resource(s). In some cases, there may not be mapping between SL PRS resource and PSCCH configuration. In such cases, based on different transmission priority of the UE 104, a relatively higher priority can access the channel and transmit the SL PRS relatively sooner, for example.

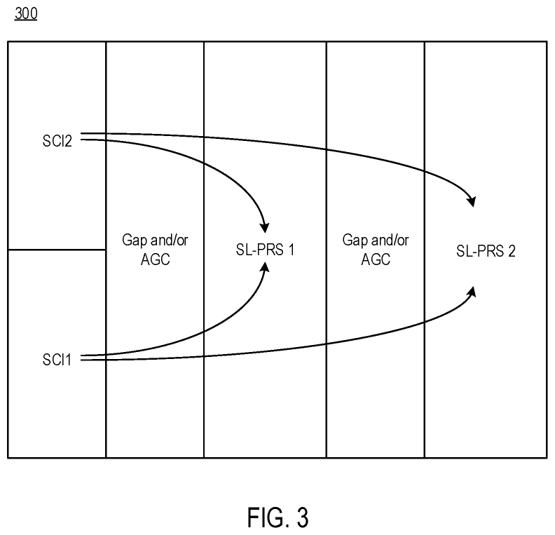

For example, FIG. 3 shows an example depiction 300 of transmissions of sidelink control information (SCI) 1 and SCI 2. As shown, consider the scenarios where the UE 1 and UE 2 (e.g., UE-A or UE-B, respectively, or vice versa) successfully access the channel, the UE 1 transmits SCI 1, and UE 2 transmits SCI 2. According to the resource pool (pre-)configuration, the SCI 1 and SCI 2 can be associated with SL PRS1 and SL PRS 2. In such cases, if the priority of the transmission of the UE 1 is relatively greater/higher than UE 2, the UE 1 can access the channel prior to UE 2, and transmit SL PRS 1, where the UE 2 can transmit SL PRS 2 (e.g., without SL PRS 1) because of the relatively shorter CPE length.

In such scenarios, it may be challenging for the transmitting (Tx) UE to determine/decide the SL PRS resource ID field in the SCI, since it may be flexible for Tx UE to choose and compete with other devices. In such cases, in sidelink positioning on an unlicensed spectrum, a shared resource pool can be supported, while the dedicated resource pool for SL PRS may not supported, for example.

### Example Implementation 6: SL Positioning Measurement Period Condition (e.g., Requirement)

In various configurations, for an SL positioning purpose, the UE 104 can receive a location information request and assistance data from another UE and/or LMF via SLPP signaling (or other signalings). The UE 104 may be capable of measuring multiple SL positioning measurements during a measurement period. The multiple SL positioning measurements may be reported in response to the location information request. The multiple SL positioning measurements can be at least one of: SL PRS reference signal time difference (RSTD) measurement(s), SL PRS relative time of arrival (RTOA) measurement(s); SL PRS Rx-Tx (e.g., reception and transmission) time difference measurement(s) for SL RTT method, SL PRS reference signal received power (RSRP) measurement(s), SL PRS reference signal received path power (RSRPP) measurement(s), SL angle of arrival (AoA), etc.

In some cases, the UE 104 can report its capability for at least one of: maximum number of active or occupied SL PRS resources across all configured resource pools that the UE 104 is processing in a time duration (e.g., the time duration can be a slot, or represented in a unit of ms, etc.); a minimum time after the end of a slot carrying an SL-PRS resource for the UE 104 to finish the SL-PRS resource processing and preparing the positioning measurement report for instance given that the active or occupied SL-PRS resources during this time duration have not exceeded the reported capabilities and given that a maximum SL PRS bandwidth in MHz; a number of PSCCH resource and/or SL PRS resource the UE 104 can process in a time duration, where the time duration can be a slot, represented in a unit of ms, etc.; and/or a number of SL PRS symbols the UE 104 can process in a second time duration.

In some cases, the UE 104 can be requested by the LMF or the server UE 104 to report the location information. The request signaling can include at least one of but not limited to: whether the UE 104 is requested to measure the same SL PRS resource with multiple Rx timing error groups (TEGs); the number of Rx TEGs with which the UE 104 is requested to measure a SL PRS resource; whether the UE 104 is requested to measure the same SL PRS resource with multiple Rx antenna reference points (ARPs), the number of Rx ARPs with which the UE 104 is requested to measure a SL PRS resource; and/or whether the UE 104 is requested to report multiple Rx-Tx measurements for the same SL PRS resource reception.

In some implementations, different from Uu positioning where DL PRS is periodic, various SL PRS transmissions can be aperiodic. For example, for SL PRS resource allocation scheme 2 (e.g., UE autonomous resource selection), the UE 104 can select resource(s) based on sensing or based on random selection. Subsequently, the measurement period required for the UE 104 receiving a measurement request can vary depending on whether the Tx UE (e.g., transmitting UE) successfully select resource(s). However, in SL PRS resource allocation scheme 1, the transmission of SL PRS can be dynamic, semi-persistent, and/or periodic.

The measurement period may be at least associated with one or more of the following: Quality of service (QoS) requirement; the delay budget of SL PRS, the selection window size (e.g., multiple minimum selection window sizes (pre-)configured in multiple resource pools, based on resource pool (pre-)configuration and delay budget), the periodicity of CG for SL positioning, the least common multiple (LCM) of the CG periodicities, the resource reservation period of SL PRS, the maximum number of active (or occupied) SL PRS resources across all configured resource pools that the UE 104 is processing in a time duration (e.g., the time duration can be a slot, or represented in the unit of ms) N₁; a maximum number of SL PRS resources (pre-)configured across various configured resource pools in a time duration (e.g., the time duration can be a slot, or represented in the unit of ms) N₂; a minimum time after the end of a slot carrying a SL-PRS resource for the UE 104 to finish the SL-PRS resource processing and preparing the positioning measurement report assuming or according to the active or occupied SL-PRS resources during this time have not exceeded the reported capabilities and according to a maximum SL PRS bandwidth in MHz, which may be supported and reported by the UE 104; a number of UEs 104 whose SL PRS are to be measured; the number of resource pools to be measured; the number of SL PRS symbols the UE 104 can process in a second time duration, the number of samples, the number of PSCCH resource the UE 104 can receive in a time duration the time duration can be a slot, or represented in unit of ms, etc.), number of PSCCH resource and/or SL PRS resource the UE 104 can process in a time duration (e.g., the time duration can be a slot, or represented in the unit of ms), whether the UE 104 is requested to measure same SL PRS resource with multiple Rx timing error groups (TEGs), the number of Rx TEGs the UE 104 can measure simultaneously (e.g., including whether the UE is capable) and the number of Rx TEGs with which the UE 104 is requested to measure a SL PRS resource, whether or not the UE 104 is requested to measure same SL PRS resource with multiple Rx antenna reference points (ARPs), and/or the number of Rx ARPs UE can measure simultaneously (e.g., including whether UE is capable) and the number of Rx ARPs with which the UE 104 is requested to measure a SL PRS resource. In some examples, the measurement period may be associated with ceil

$$( \frac{{N}_{1}}{{N}_{2}} ) .$$

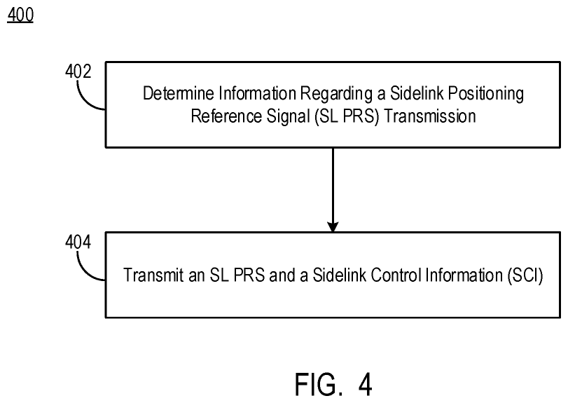

FIG. 4 is a flow diagram illustrating an example method 400 for sidelink positioning enhancement. The method 500 may be implemented using any one or more of the components and devices detailed herein in conjunction with FIGS. 1 to 3. In brief overview, the method 400 can be performed by one or more network devices, such as one or more wireless communication devices (e.g., UE(s) 104), at least one wireless communication node (e.g., BS, gNB, or TRP), and/or at least one network function (e.g., LMF), etc., in some embodiments. Additional, fewer, or different operations may be performed in the method 400 depending on the embodiment. At least one aspect of the operations is directed to a system, method, apparatus, or a computer-readable medium.

At operation 402, a first wireless communication device (e.g., UE-B) can determine information regarding a Sidelink Positioning Reference Signal (SL PRS) transmission, in response to the first wireless communication device receiving a positioning request. At operation 404, the first wireless communication device can transmit/send/provide/communicate/forward an SL PRS and a Sidelink Control information (SCI) corresponding to the SL PRS based on the information regarding the SL PRS transmission.

In n some implementations, the first wireless communication device can receive/obtain/acquire the positioning request from at least one of: a higher layer (e.g., application layer) of the first wireless communication device, and/or a second wireless communication device (e.g., the UE-A).

In some implementations, one or more wireless communication devices may receive the SCI and associated SL PRS resources from a second wireless communication device. For example, in this case, the first wireless communication device can be one of the one or more wireless communication devices. The SCI transmitted by the second wireless communication device can include at least one of: a cast type, a source ID, a destination ID, and/or an SL PRS request field.

In some implementations, the positioning request in SCI, which may be transmitted by the second wireless communication device, and the SL PRS resources, which may be transmitted by the second wireless communication device, can share at least one of: a same cast type, a same source ID, and/or a same destination ID, among others. In some implementations, a positioning request field in the SCI may be inactivated/disabled, for instance, in response to at least one of the following conditions being satisfied: the SL PRS request field is not preconfigured, configured, or enabled in a resource pool; the cast type is indicated as broadcast; and/or the cast type is indicated as groupcast.

In some implementations, the SCI may further include a requested ID. The requested ID can be configured for indicating which of the one or more wireless communication devices is requested to transmit an SL PRS in response to the positioning request. In some implementations, the requested ID can include at least one of: a UE ID indicated by a first higher layer, a source ID indicated by a second higher layer, and/or a member ID for groupcast case which may be indicated by a third higher layer and represents a member in a group.

In some implementations, the first to third higher layers can each be a Sidelink Positioning Protocol (SLPP) signaling or a signaling sent from an application layer. In some implementations, the first to third higher layers can each be configured to inform which of the one or more wireless communication devices is requested to transmit an SL PRS in response to the positioning request and include SL PRS transmission characteristics.

In some implementations, the SL PRS transmission characteristics can comprise at least one of but not limited to: positioning condition; Quality of Service (QoS) condition; SL PRS transmission priority of a target wireless communication device; SL PRS configurations; latency condition; and/or a UE ID. For example, the QoS condition may include at least one of: a horizontal accuracy, a vertical accuracy, a response time, a velocity request, a SL PRS delay budget, and/or a priority, to name a few. The SL PRS configurations may include at least one of but not limited to: number of symbol, comb size, comb offset, bandwidth, sequence ID, SL PRS resource ID, resource pool ID, shared resource pool, and/or dedicated resource pool. The latency condition may include but is not limited to the first wireless communication device can be configured to transmit SL PRS within a period of time after receiving SCI with SL PRS request.

In some implementations, if the first wireless communication device and the second wireless communication device are in a same positioning session and the first wireless communication device receives the positioning request from the second wireless communication device, the first wireless communication device can be configured to transmit the SL PRS. In some implementations, a resource selection or allocation for the SL PRS transmission of the first wireless communication device from a list of wireless communication devices receiving the positioning request can account for UE information or group member information.

In some implementations, if the first wireless communication device is in SL PRS resource allocation scheme 2, such as discussed herein, the first wireless communication device can determine one or more SL PRS resource IDs for transmitting the SL PRS considering a maximum number of SL PRS resources configured or pre-configured in a resource pool and the UE information or the group member information, such as in response to the positioning request. In some implementations, if the first wireless communication device is in SL PRS resource allocation scheme 2, the first wireless communication device can determine one or more SL PRS resource pool IDs for transmitting the SL PRS, in response to the positioning request.

In some implementations, the second wireless communication device can use a Sidelink Positioning Protocol (SLPP) to recommend or configure different SL PRS characteristics for the first wireless communication device or one or more other wireless communication devices. In some implementations, the first wireless communication device can transmit/send in response to receiving the positioning request sent from the second wireless communication device, the SL PRS in either unicast, groupcast, and/or broadcast. A destination of the SL PRS transmission can be configured or pre-configured to include the second wireless communication device. For example, a new mechanism for obtaining the SL grant and determining the SL transmission information for SL positioning in the shared resource pool can be implemented because of the restricted capabilities in for instance certain legacy mechanisms.

In some implementations, the first wireless communication device can determine to transmit the SL PRS on a shared resource pool. The information regarding the SL PRS transmission can include at least one of but not limited to: a time resource, a frequency resource, an SL grant, a priority, a source ID, a destination ID, a resource pool ID, a bandwidth, a sidelink channel occupancy ratio (SL CR) limit, a maximum transmission power, an SL PRS resource ID, and/or a resource reservation interval.

In some implementations, the first wireless communication device can determine one or more SL PRS transmission parameters based on one or more delay budgets. In some implementations, the one or more delay budgets may each include a remaining delay budget of the SL PRS and a remaining packet delay budget (PDB) of SL data available in a logic channel or a unified delay budget. The unified delay budget may be a minimum value between the remaining delay budget of the SL PRS and the remaining PDB of the SL data available in the logic channel.

In some implementations, the information regarding the SL PRS transmission may be related to both of a list of PSSCH transmission parameters and a list of SL PRS transmission parameters. In some implementations, the list of SL PRS transmission parameters may be associated with a priority of the SL PRS transmission and a Channel Busy Ratio (CBR) measurement.

In some implementations, the list of PSSCH transmission parameters may be associated with a priority of PSSCH transmission and a CBR measurement. In some implementations, the information regarding the SL PRS transmission may be related to at least one of: a priority of the SL PRS, a priority of logical channels for SL data, a remaining delay budget of SL data available in a logical channel, and/or a delay budget of the SL PRS.

In some implementations, the first wireless communication device can select a destination associated with one of unicast, groupcast, and/or broadcast, having a highest priority among a priority of logical channels for SL data and a priority of the SL PRS for the SCI corresponding to the SL PRS transmission. In some implementations, the SL PRS may be transmitted by the first wireless communication device when there is a pending SL PRS under the selected destination and the pending SL PRS meets at least one restriction. The at least one restriction can include at least one of but not limited to: the pending SL PRS having the highest priority; the pending SL PRS having a lowest delay budget; and/or the pending SL PRS transmitted in response to a single positioning request is not transmitted for more than N times or more than a time duration.

In some implementations, a third wireless communication device can receive the SL PRS transmitted by the first wireless communication device. The third wireless communication device can send an indication of at least one of a relative distance, an angle, or a resource pool ID in a location information report (e.g., providing a detailed location information report for relative positioning and ranging). In some cases, if the resource ID is reported in the measurement report without the resource pool ID, an SL PRS resource ID in different SL PRS resource pools may associate with a different number of symbols and comb pattern of SL PRS, etc. In some implementations, the first wireless communication device can perform partial sensing to select available resources for the SL PRS transmission. At least one of but not limited to: the partial sensing can be performed in SL Discontinuous Reception (DRX) inactive time based on resource pool configuration; SL PRS Received Signal Strength Indicator (RSSI) of a Channel Busy Ratio (CBR) may be measured in SL PRS resources where the first wireless communication device performs the partial sensing; and/or a CBR may be used if a threshold is not met where the threshold is calculated by a number of SL PRS resources in a CBR window. In such cases, power consumption can be minimized or reduced for the first wireless communication device to perform the SL positioning.

In some implementations, the first wireless communication device can transmit the SL PRS in an unlicensed band. The selection of cyclic prefix extension (CPE) starting position or CPE length may be associated with a priority value of the SL PRS transmission. In this case, the SL PRS transmission with a higher priority can have a relatively higher likelihood to successfully access the channel for SL positioning in unlicensed spectrum, for example.

In some implementations, a third wireless communication device can receive and measure SL PRS from one or more other wireless communication devices. The third wireless communication device can perform (or finish) one or more SL PRS measurements within a measurement period, where at least one of: the first wireless communication device can be one of the one or more other wireless communication devices; the third wireless communication device can receive a location information request from another wireless communication device or a network function via a Sidelink Positioning Protocol (SLPP) signaling; and/or the third wireless communication device can receive an assistance data from another wireless communication device or a network function via an SLPP signaling for measuring the SL PRS.

In some implementations, the measurement period can be associated with at least one of: quality of service (QoS) condition (or requirement), one or more delay budgets of the SL PRS transmission; one or more selection window sizes; one or more periodicities of (configured grant (CG) for SL positioning; one or more resource reservation period of SL PRS; a maximum number of active SL PRS resources across configured resource pools that one or more wireless communication devices are processing in a time duration; and/or maximum number of SL PRS resources (pre-)configured across configured resource pools in a time duration. For example, in this case, the wireless communication device can complete/finish one or more SL PRS measurements within a measurement period requirement, thereby satisfying the QoS conditions (or requirements or criteria).

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, comprising:
determining, by a first wireless communication device, information regarding a Sidelink Positioning Reference Signal (SL PRS) transmission, in response to the first wireless communication device receiving a positioning request; and
transmitting, by the first wireless communication device, an SL PRS and a Sidelink Control information (SCI) corresponding to the SL PRS based on the information regarding the SL PRS transmission.

2. The wireless communication method of claim 1, wherein the first wireless communication device receives the positioning request from:
a higher layer of the first wireless communication device; or
a second wireless communication device.

3. The wireless communication method of claim 1, further comprising:
determining, by the first wireless communication device, to transmit the SL PRS on a shared resource pool,
wherein the information regarding the SL PRS transmission includes at least one of: a time resource, a frequency resource, a priority, a source ID, a destination ID, a resource pool ID, an SL PRS resource ID, or a resource reservation interval.

4. The wireless communication method of claim 3, further comprising:
determining, by the first wireless communication device, one or more SL PRS transmission parameters based on one or more delay budgets.

5. The wireless communication method of claim 4, wherein the one or more delay budgets includes a remaining delay budget of the SL PRS and a remaining packet delay budget (PDB) of SL data available in a logic channel or a unified delay budget, wherein the unified delay budget is a minimum value between the remaining delay budget of the SL PRS and the remaining PDB of the SL data available in the logic channel.

6. The wireless communication method of claim 3, wherein the first wireless communication device selects a destination associated with one of unicast, groupcast, or broadcast, having a highest priority among a priority of logical channels for SL data and a priority of the SL PRS for the SCI corresponding to the SL PRS transmission.

7. A first wireless communication device, comprising:
at least one processor configured to:
determine information regarding a Sidelink Positioning Reference Signal (SL PRS) transmission, in response to the first wireless communication device receiving a positioning request; and
transmit, via a transmitter, an SL PRS and a Sidelink Control information (SCI) corresponding to the SL PRS based on the information regarding the SL PRS transmission.

8. The wireless communication device of claim 7, wherein the at least one processor is configured to receive, via a receiver, the positioning request from:
a higher layer of the first wireless communication device; or
a second wireless communication device.

9. The wireless communication method of claim 7, wherein the at least one processor is configured to:
determine to transmit the SL PRS on a shared resource pool,
wherein the information regarding the SL PRS transmission includes at least one of: a time resource, a frequency resource, a priority, a source ID, a destination ID, a resource pool ID, an SL PRS resource ID, or a resource reservation interval.

10. The wireless communication method of claim 9, wherein the at least one processor is configured to:
determine one or more SL PRS transmission parameters based on one or more delay budgets.

11. The wireless communication method of claim 10, wherein the one or more delay budgets includes a remaining delay budget of the SL PRS and a remaining packet delay budget (PDB) of SL data available in a logic channel or a unified delay budget, wherein the unified delay budget is a minimum value between the remaining delay budget of the SL PRS and the remaining PDB of the SL data available in the logic channel.

12. The wireless communication method of claim 9, wherein the at least one processor is configured to select a destination associated with one of unicast, groupcast, or broadcast, having a highest priority among a priority of logical channels for SL data and a priority of the SL PRS for the SCI corresponding to the SL PRS transmission.

13. A wireless communication method, comprising:
receiving, by a second wireless communication device from a first wireless communication device, a Sidelink Positioning Reference Signal (SL PRS) and a Sidelink Control information (SCI) corresponding to the SL PRS based on information regarding the SL PRS transmission,
wherein the information regarding the SL PRS transmission is determined in response to the first wireless communication device receiving a positioning request.

14. The wireless communication method of claim 13, wherein the positioning request is from:
a higher layer of the first wireless communication device; or
a second wireless communication device.

15. The wireless communication method of claim 13, wherein the information regarding the SL PRS transmission includes at least one of: a time resource, a frequency resource, a priority, a source ID, a destination ID, a resource pool ID, an SL PRS resource ID, or a resource reservation interval.

16. The wireless communication method of claim 15, one or more SL PRS transmission parameters are determined based on one or more delay budgets.

17. A second wireless communication device, comprising:
at least one processor configured to:
receive, via a receiver from a first wireless communication device, a Sidelink Positioning Reference Signal (SL PRS) and a Sidelink Control information (SCI) corresponding to the SL PRS based on information regarding the SL PRS transmission,
wherein the information regarding the SL PRS transmission is determined in response to the first wireless communication device receiving a positioning request.

18. The second wireless communication device of claim 17, wherein the positioning request is from:
a higher layer of the first wireless communication device; or
a second wireless communication device.

19. The second wireless communication device of claim 17, wherein the information regarding the SL PRS transmission includes at least one of: a time resource, a frequency resource, a priority, a source ID, a destination ID, a resource pool ID, an SL PRS resource ID, or a resource reservation interval.

20. The second wireless communication device of claim 19, wherein one or more SL PRS transmission parameters are determined based on one or more delay budgets.
